(19) United States
(12) Patent Application Publication
(10) Pub. No.: US 2012/0079526 A1
(43) Pub. Date: Mar. 29, 2012

(54) METHOD AND APPARATUS FOR PROVIDING CROSS-SYSTEM SEARCHES

(75) Inventors: Japan Mehta, Coppell, TX (US); Shafiq Kassam, Lewisville, TX (US); Enrique Ruiz-Velasco, Flower Mound, TX (US)

(73) Assignee: VERIZON PATENT AND LICENSING INC., Basking Ridge, NJ (US)

(21) Appl. No.: 12/890,827

(22) Filed: Sep. 27, 2010

(51) Int. Cl. H04N 7/16; H04N 5/445

(52) U.S. Cl. 725/30; 725/53

(57) ABSTRACT

An approach is provided for perform search across multiple systems via a set-top box. A search request is received via an interactive service guide of a set-top box. A widget-based search of one or more applications is initiated via the set-top box. A search result for the one or more applications is received, and presented via the interactive service guide.

### BACKGROUND INFORMATION

With the advent of computers, interactive electronic communications, and the Internet, as well as advances in the digital realm of consumer information, has come a reinvention of conventional entertainment and communication services to enhance programming, recording, and viewing of multimedia, such as broadcast television programs. Traditionally, broadcast media, being based on pre-computer age technology, has developed on its own path, without any regard to other media systems. With readily available, cost-effective broadband services, bandwidth intensive applications, such as audio and video streaming, have become viable mediums. Also, there has been substantial growth in the use of set-top boxes (STBs) as the focal point for media consumption. It is not uncommon for consumers to have access to hundreds, if not thousands, of media programs and applications (e.g., widgets that provide specialized content delivery) from a multitude of sources such as broadcast television, on-demand programming, and other third party content providers available through the Internet. However, while the choices of content available to consumers have progressed, the way consumers access and view those choices have not kept pace. In many cases, a consumer has to sift through, for instance, a programming guide including thousands of programs to discover programs of interest of to the consumer. As a result, the consumer often is either unable to find or cannot easily find the programs that the consumer would like to view.

Therefore, there is a need for an approach that provides flexible, efficient techniques to search through content through the convenience of a set-top box.

### BRIEF DESCRIPTION OF THE DRAWINGS

Various exemplary embodiments are illustrated by way of example, and not by way of limitation, in the figures of the accompanying drawings in which like reference numerals refer to similar elements and in which:

FIG. 1 is a diagram of a system capable of providing search functions across multiple applications, according to an exemplary embodiment;

FIG. 2 is a flowchart of a process for searching using a set-top box, according to an exemplary embodiment;

FIG. 3 is a diagram of a widget-based search process, according to an exemplary embodiment;

FIG. 4 is a diagram of a search platform configured to provide search capability to content processing devices (e.g., set-top boxes), according to an exemplary embodiment;

FIG. 5 is a flowchart of a process for registering widgets to perform searches, according to an exemplary embodiment;

FIG. 6 is a flowchart of a process for setting privacy options for searches, according to an exemplary embodiment;

FIG. 7 is a diagram of a content processing device (e.g., set-top box) configured to process search requests, according to an exemplary embodiment;

FIG. 8 is a diagram of a graphical user interface (GUI) presented via a set-top box for providing search operations, according to an exemplary embodiment;

FIG. 9 is a diagram of a computer system that can be used to implement various exemplary embodiments; and

FIG. 10 is a diagram of a chip set that can be used to implement various exemplary embodiments.

### DESCRIPTION OF THE PREFERRED EMBODIMENT

A preferred apparatus, method, and software for searching content across multiple systems via a set-top box are described. In the following description, for the purposes of explanation, numerous specific details are set forth in order to provide a thorough understanding of the preferred embodiments of the invention. It is apparent, however, that the preferred embodiments may be practiced without these specific details or with an equivalent arrangement. In other instances, well-known structures and devices are shown in block diagram form in order to avoid unnecessarily obscuring the preferred embodiments of the invention.

Although various exemplary embodiments are described with respect to a set-top box (STB), it is contemplated that these embodiments have applicability to any device capable of processing content (e.g., audio/video (AV)) signals for presentation to a user, such as a home communication terminal (HCT), a digital home communication terminal (DHCT), a stand-alone personal video recorder (PVR), a television set, a digital video disc (DVD) player, a video-enabled phone, an audio/video-enabled personal digital assistant (PDA), and/or a personal computer (PC), as well as other like technologies and customer premises equipment (CPE).

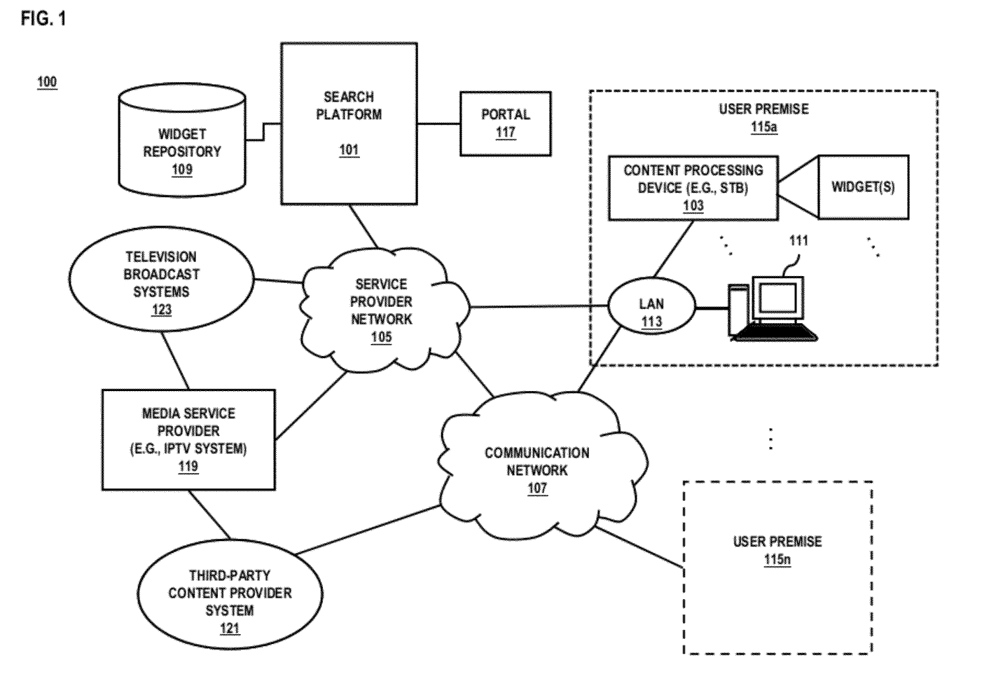

FIG. 1 is a diagram of a system capable of providing search functions across multiple applications, according to an exemplary embodiment. For the purposes of illustration, system 100 is described with respect to a search platform (or platform) 101 that is configured to interface with content processing devices (e.g., set-top boxes (STBs)) 103 through service provider network 105 and/or communication network 107. As noted, the variety and voluminous nature of programs and applications made available to consumers are increasing more difficult to manage. In certain embodiments, search platform 101 provides a search engine that utilizes a “master” application, e.g., widget that interfaces with a number of other widgets for searching content within applications corresponding to these respective widgets. As “mini-applications,” widgets generally provide single-purpose services, and thus, users can select the particular services to suit their needs. Also, widgets do not consume significant resources of the STB. Moreover, as the activation of such widgets can launch other applications for a richer user experience. It is contemplated that STBs can integrate widgets (as specified by the user) with their interactive service guides—as an overlay, for example; additionally, the widgets can overlay on media content.

It is observed that even with the advent of the Internet and high-speed data connections, television remains the prevalent global medium for entertainment and information. For example, television users continue to be presented with an ever increasing amount and variety of programming choices. It is not uncommon for television users to have access to hundreds of programming channels dedicated to any of a number subjects. In fact, as traditional television programming (e.g., “over-the-air” programming, cable programming, satellite programming, etc.) merges with the online content (e.g., network-streamed content, on-demand content, Internet programming, media-sharing websites, etc.), the available programming choices are likely to continue to explode. For example, internet protocol television (IPTV) service providers are currently offering subscribers various video services ranging from multi-channel video programming that mimics traditional broadcast television, to true video-on-demand (VOD) programming. These services are further supplemented with interactive video applications that enable robust programming content, selection and navigation functionality, as well as integrated digital video recording, and data services to enhance the video experience. These shared protocols create integrated value propositions with regard to accessible content.

Furthermore, content and associated services offered by the global Internet can be accessed through widgets, which can reside within STB 103 and/or other devices throughout a service provider network 105 and communication 107. In one embodiment, widgets can be stored within a dedicated widget repository 109 and downloaded onto STB 103.

Conventionally, search capabilities provided by STBs have been limited, if even possible, to program guide information. However, as noted in addition to programs, applications can be accessible via STBs; but no such search function exists with respect to how content within these applications can be searched.

Thus, it is apparent that improvements are needed to provide consumers with the ability to experience the growing applications and programming content conveniently and efficiently. Accordingly, the system 100 of FIG. 1 provides a query or search function that can find content across different applications and systems. By way of example, a master widget within search platform 101 can receive search requests from a subscriber via the subscriber's STB for processing by other widgets that have been registered for the particular subscriber. The master widget can pass the necessary search parameters to these other widgets for performing the requested search. These other widgets can then perform the search within their corresponding applications. Thereafter, the results are provided to the master widget.

By way of example, content processing device 103 and computing device 111 can communicate over a local area network (LAN) 113 of a user premise 115. In this manner, routers (not shown) may be used for establishing and operating, or at least connecting to, a network such as a “home” network or LAN 113, and is used to route communications within user premises 115a-115n. For example, content processing device 103 may be a set-top box communicatively coupled to LAN 113 via a router and a coaxial cable, whereas computing devices 115 may be connected to LAN 113 via a router and a wireless connection, a network cable (e.g., Ethernet cable), and/or the like. It is noted, however, that in certain embodiments content processing device 103 may be configured to establish connectivity with LAN 113 via one or more wireless connections. Further, content processing device 103 and computing device 111 may be uniquely identified by LAN 113 via any suitable addressing scheme. For example, LAN 113 may utilize the dynamic host configuration protocol (DHCP) to dynamically assign “private” DHCP internet protocol (IP) addresses to content processing device 103 and computing devices 111, i.e., IP addresses that are accessible to devices such as devices 103 and 111 that are part of LAN 113 facilitated via router, i.e., connected to a router.

Computing device 111 can also access portal 117 to communicate with search platform 101 to specify certain user preferences, for example. In one embodiment, user preferences (e.g., privacy options) relating to the search capability of platform 101 can be specified via portal 117.

It is noted that user premises 115a-115n may be geospatially associated with one or more regions, as well as one or more user accounts. As such, content processing devices 103 associated with user premises 115a-115n may be configured to communicate with and receive information from search platform 101.

Additionally, content processing devices 103 may be configured to communicate with and receive signals and/or data streams from media service provider (MSP) 119 (or other transmission facility, e.g., third-party content provider system 121). These signals may include media content retrieved over a data network (e.g., service provider network 105 and/or communication network 107), as well as conventional video broadcast content.

In certain embodiments, content broadly includes any application, audio-visual content (e.g., broadcast television programs, VOD programs, pay-per-view programs, IPTV feeds, DVD related content, etc.), pre-recorded media content, data communication services content (e.g., commercials, advertisements, videos, movies, songs, images, sounds, etc.), Internet services content (streamed audio, video, or image media), and/or any other equivalent media form. In this manner, MSP 119 may provide (in addition to their own media content) content obtained from sources, such as one or more third-party content provider systems 121, one or more television broadcast systems 123, etc., as well as content available via one or more communication networks 107, etc.

Communication network 107 can include: a public data network (e.g., the Internet), various intranets, local area networks (LAN), wide area networks (WAN), the public switched telephony network (PSTN), integrated services digital networks (ISDN), other private packet switched networks or telephony networks, as well as any additional equivalent system or combination thereof. These networks may employ various access technologies including cable networks, satellite networks, subscriber television networks, digital subscriber line (DSL) networks, optical fiber networks, hybrid fiber-coax networks, worldwide interoperability for microwave access (WiMAX) networks, wireless fidelity (WiFi) networks, other wireless networks (e.g., 3G wireless broadband networks, mobile television networks, radio networks, etc.), terrestrial broadcasting networks, provider specific networks (e.g., fiber optic networks, cable networks, etc), and the like. Such networks may also utilize any suitable protocol supportive of data communications, e.g., transmission control protocol (TCP), internet protocol (IP), file transfer protocol (FTP), telnet, hypertext transfer protocol (HTTP), hypertext transfer protocol secure (HTTPS), asynchronous transfer mode (ATM), socket connections, Ethernet, frame relay, and the like, to connect content processing devices 103 to various sources of media content, such as one or more third-party content provider systems 121. Although depicted in FIG. 1 as separate networks, communication network 107 may be completely or partially contained within service provider network 105. For example, service provider network 105 may include facilities to provide for transport of packet-based communications.

While system 100 is illustrated in FIG. 1, the exemplary components are not intended to be limiting, and indeed, additional or alternative components and/or implementations may be utilized.

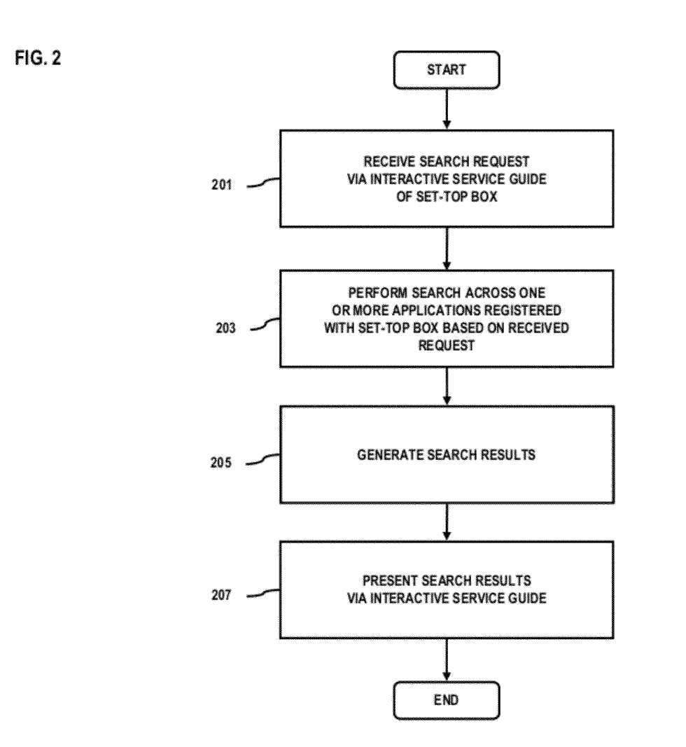

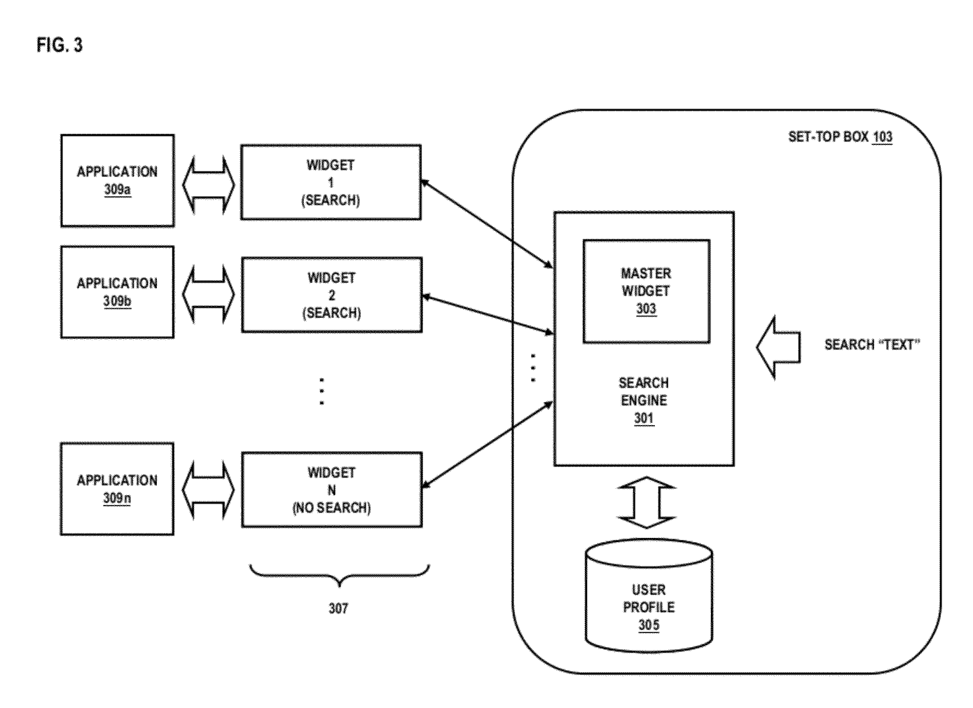

FIG. 2 is a flowchart of a process for searching using a set-top box, according to an exemplary embodiment. In step 201, a search request is received from a user at set-top box 103. In one embodiment, the user can provide such input through a remote control device, a computing device in communication with set-top box 103, or an input mechanism provided by set-top box 103 itself. After receiving the search request, set-top box 103 can execute, according to one embodiment, a search engine that utilizes a master widget to interface with one or more widgets to perform a search for content across the applications corresponding to these widgets (as depicted in FIG. 3), per step 203. Alternatively, the search request can be relayed by set-top box 103 to search platform 101 for processing. In step 205, the search results are aggregated, and presented to the user, per step 207; in one embodiment, these results can be displayed as part of an interactive service guide of set-top box 103.

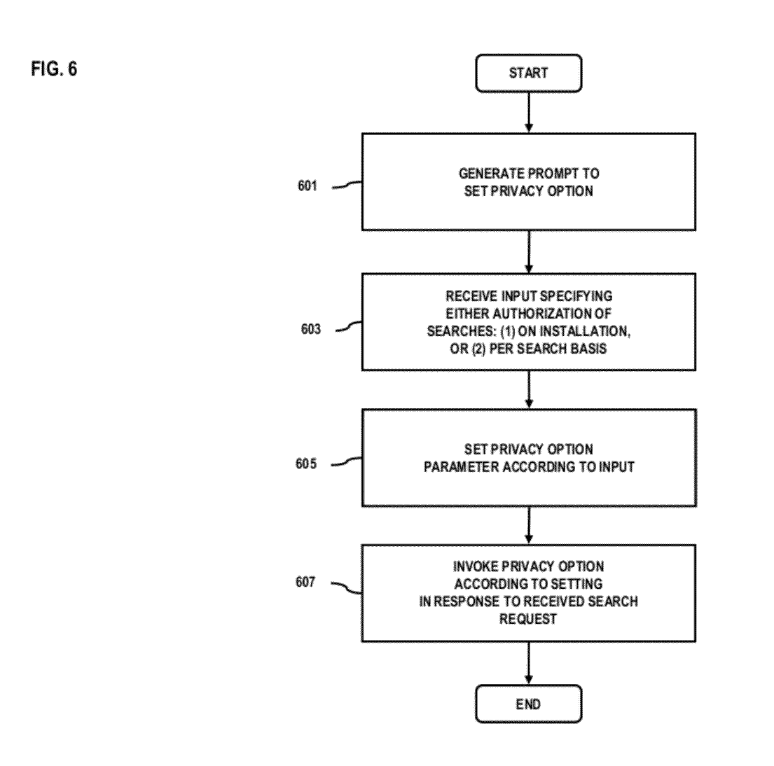

FIG. 3 is a diagram of a widget-based search process, according to an exemplary embodiment. Under this scenario, set-top box 103 is configured with a search engine 301, which provides a master widget 303 to find content that is requested in a search query. Moreover, the search capability can be defined based on parameters specified in a user profile 305. In one embodiment, one such parameter can involve a privacy option, whereby the user can indicate whether authorization is required to execute searches. Also, another privacy related parameter can indicate whether the search function is effective for all searches upon installation, or on a search-by-search basis. The process for setting this privacy option is more fully described with respect to FIG. 6.

A search request is received by search engine 301. By way of example, an alphanumeric string, e.g., “TEXT,” is the subject of the query. Such a scenario can reflect an instance in which a user seeks certain types of applications by a common trait or value—e.g., “sports statistics.” As shown, master widget 303 communicates with one or more widgets 307a-307n, which may or may not be configured as search widgets. For example, widget 1 and widget 2 are illustrated as having a search function, while widget n does not possess such capability or is not authorized (e.g., as dictated by privacy option parameters). In this example, each of the widgets 307 interfaces with a corresponding application 309a-309n. These applications 309a-309n can reside on variety of disparate computing systems (not shown) across the networks 105, 107. Moreover, anyone of the widgets 307 may also reside within set-top box 103, in fact. Because no search function exists with widget n, application 309n is not searched. Nonetheless, the search request for “text” can be performed for the other applications 309a, 309b.

According to one embodiment, search capable widgets (widget 1 and widget 2) are specified by a Uniform Resource Locator (URL) to indicate the location of the corresponding applications (applications 309a and 309b).

The above arrangement depicts embodiments in which the search is processed locally at the set-top box 103. However, it is contemplated that this search function can be part of a managed service of a service provider through the use of a network-based search service provided by search platform 101.

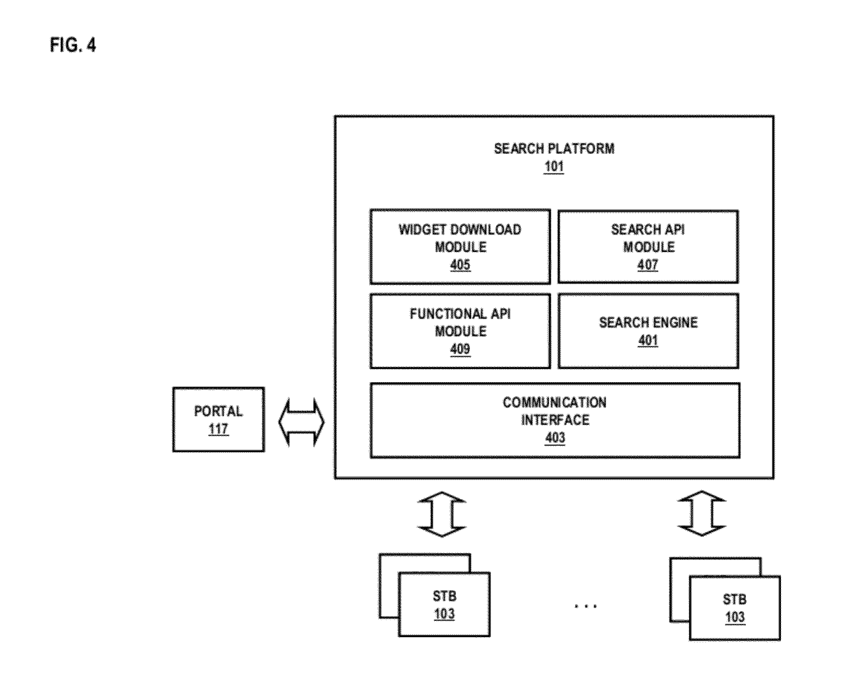

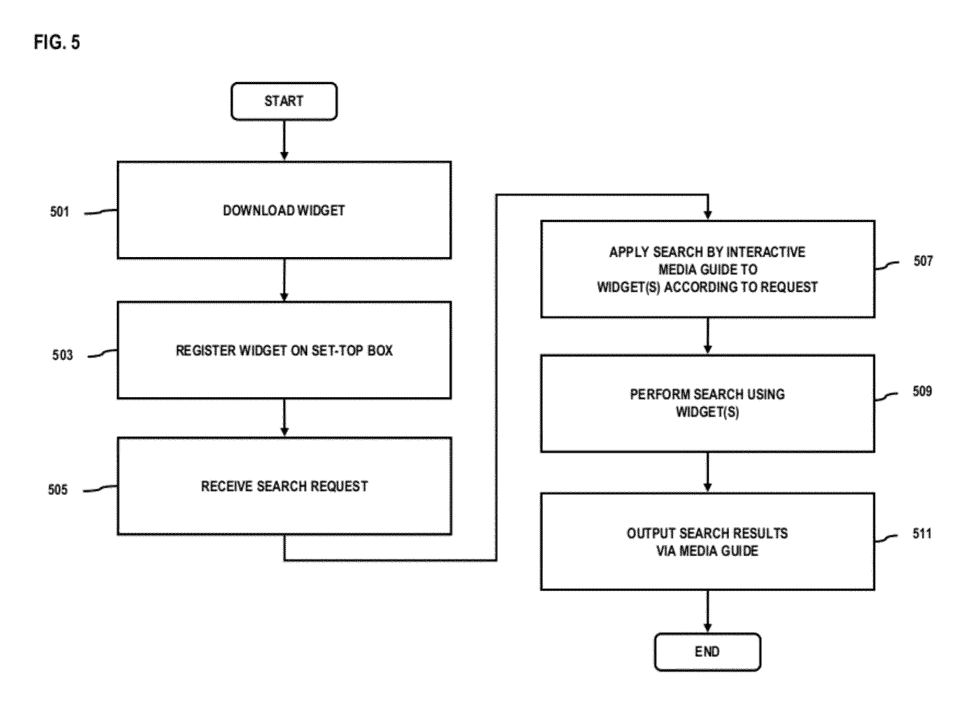

FIG. 4 is a diagram of a search platform configured to provide search capability to content processing devices (e.g., set-top boxes), according to an exemplary embodiment. By way of example, search platform 101 includes a search engine 401, which interacts with set-top box 103 over a communication interface 403. According to one embodiment, search platform 101 provides a widget download module 405, which permits STB 103 to retrieve widgets from repository 109. This process is detailed below with respect to FIG. 5. Search platform 101 additionally offers an application programming interface (API) for the search function via module 407, thereby enabling other devices and network elements to exploit the described search capabilities. Furthermore, a functional API module 409 extends the search capability to processes other than widgets.

FIG. 5 is a flowchart of a process for registering widgets to perform searches, according to an exemplary embodiment. For the purposes of illustration, this process involves the retrieval of widgets that are stored within widget repository 109. It is contemplated, however, that the widgets can reside anywhere within service provider network 105 and/or communication network 107, depending on the particular services that can be accessed by STB 103. In step 501, STB 103 initiates communication with search platform 101 to access a widget stored within repository 109, wherein the download module 405 coordinates the necessary protocol exchange to ensure delivery of the widget to STB 103. The retrieved widget undergoes a registration process, as in step 503, so that the subscriber is cognizant of which widgets are authorized and approved to be used at STB 103. The retrieved widget, initially, may be a master widget, which can then communicate with other widgets throughout the network 105 and/or network 107. Subsequently, other widgets can be downloaded through this process as well.

In step 505, a search request for certain content is received. Next, the process performs the search, in one embodiment, using an interactive media guide of STB 103 to interact with the master widget according to the request, as in steps 507 and 509. The master widget can coordinate the search parameters and results with the other widgets, and output the aggregate search results via the media guide, per step 511.

Associated with the search function are various options that the user can specify. One such option relates to authorization of the searches, as next described.

FIG. 6 is a flowchart of a process for setting privacy options for searches, according to an exemplary embodiment. In step 601, a prompt is generated to set a privacy option. In this example, a user can be presented with the prompt via an interactive program guide of STB 103. The prompt can state, e.g.: “To set the PRIVACY OPTION, please enter whether the search authorization is set for all searches on (1) INSTALLATION, or (2) PER SEARCH BASIS.” It is contemplated that STB 103 can be configured to accept the user selection through any input mechanism. For instance, the user may utilize a cursor controller to highlight the selected option. In this case, if Option (1) is to be selected, STB 103 can highlight this option. In step 603, the user input is received by STB 103, which then sets a privacy option parameter accordingly, as in step 605. Thereafter, the user specified privacy option can be invoked in response to the subsequent search queries, per step 607.

According to one embodiment, the privacy option can be set to a default value, e.g., Option (1) INSTALLATION. Moreover, it is contemplated that other options and parameters can be utilized, depending on the application; for example, one privacy parameter may restrict the type of content that can be searched.

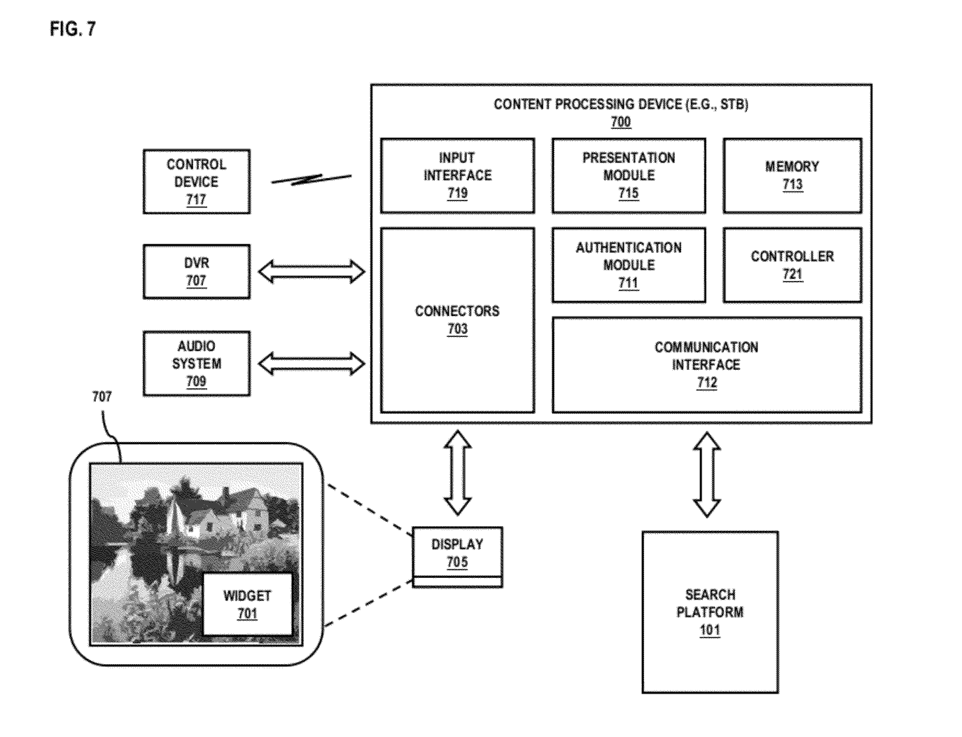

FIG. 7 is a diagram of a content processing device (e.g., set-top box) configured to process search requests, according to an exemplary embodiment. Content processing device (or device) 700 may comprise any suitable technology to receive content, for example, from a media source, such as MSP 119 and one or more third-party content provider systems 121. The content may include media content retrieved over one or more data networks (e.g., networks 105 and/or 107), in response to commands from one or more applications (e.g., widget 701).

According to various embodiments, device 700 may also include inputs/outputs (e.g., connectors 703) to display 705 and digital video recorder (DVR) 707, as well as to audio system 709. As used herein, a DVR or PRV (personal video recorder) device can be either a standalone DVR or an integrated unit of content processing device 700 and DVR. Audio system 709 may comprise a conventional audio-video receiver capable of monaural or stereo sound, as well as multichannel surround sound. Audio system 709 may include speakers, ear buds, headphones, or any other suitable component configured for personal or public dissemination. As such, content processing device 700, display 705, DVR 707, and audio system 709, for example, may support high resolution audio and/or video streams, such as high definition television (HDTV) or digital theater systems high definition (DTS-HD) audio. Thus, content processing device 700 may be configured to encapsulate data into a proper format with required credentials before transmitting onto one or more of the networks of FIG. 1 and de-encapsulate incoming traffic to dispatch data to display 705 and/or audio system 709.

In an exemplary embodiment, display 705 and/or audio system 709 may be configured with internet protocol (IP) capability (i.e., includes an IP stack, or is otherwise network addressable), such that the functions of content processing device 700 may be assumed by display 705 and/or audio system 709. In this manner, an IP ready, HDTV display or DTS-HD audio system may be directly connected to one or more service provider networks 105 and/or communication networks 107. Although content processing device 700, display 705, DVR 707, and audio system 709 are shown separately, it is contemplated that these components may be integrated into a single component, or other combination of components.

An authentication module 711 may be provided by content processing device 700 to initiate or respond to authentication schemes of, for instance, service provider network 105, third-party content provider systems 121, or various other content providers, e.g., television broadcast systems 123, etc. Authentication module 711 may provide sufficient authentication information, e.g., a user name and password, a key access number, a unique machine identifier (e.g., MAC address), and the like, as well as combinations thereof, to a corresponding communications (or network) interface 712 for establishing connectivity, via LAN 113, and to DVR management platform 101. Authentication at content processing device 700 may identify and authenticate a second device (e.g., computing device 111) communicatively coupled to, or associated with, content processing device 700, or vice versa. Further, authentication information may be stored locally at memory 713, in a repository (not shown) connected to content processing device 700, or at a remote repository (e.g., user profile repository 111).

Authentication module 711 may also facilitate the reception of data from single or disparate sources. For instance, content processing device 700 may receive broadcast video from a first source (e.g., MSP 119), signals from a media application at second source (e.g., computing device 111), and a media content stream from a third source accessible over communication networks 107 (e.g., third-party content provider system 121). As such, display 705 may present the broadcast video, media application, and media content stream to the user, wherein content processing device 700 (in conjunction with one or more media applications) can permit users to experience various sources of media content traditionally limited to the data domains. This presentation may be experienced separately, concurrently, in a toggled fashion, or with zooming, maximizing, minimizing, or trick capabilities, or equivalent mode. In other exemplary embodiments, authentication module 711 can authenticate a user to allow them to interact with one or more third-party subscriber account features associated with third-party content provider systems 121.

Presentation module 715 may be configured to receive media content streams (e.g., audio/video feed(s) including media content retrieved over a data network) and output a result via one or more connectors 703 to display 705 and/or audio system 709. In this manner, presentation module 715 may also provide a user interface for a media application via display 705. Aural aspects of media applications may be presented via audio system 709 and/or display 705. In certain embodiments, widget 701 may be overlaid on the video content output of display 705 via presentation module 715. The media content streams may include content received in response to user input specifying media content that is accessible by way of one or more third party content provider systems 105 and, thereby, available over at least one data network (e.g., network 105 and/or 107), wherein the media content may be retrieved and streamed by content processing device 700 for presentation via display 705 and/or audio system 709. Accordingly, presentation module 715 may be configured to provide lists of search results (provided from search platform 101, according to one embodiment) and/or identifiers to users for selection of media content to be experienced. Exemplary search results and/or identifiers may include graphical elements, channels, aural notices, or any other signifier, such as a uniform resource locator (URL), phone number, serial number, registration number, MAC address, code, etc.

Connector(s) 703 may provide various physical interfaces to display 705, audio system 709, as well as other peripherals; the physical interfaces may include, for example, RJ45, RJ11, high definition multimedia interface (HDMI), optical, coax, FireWire, wireless, and universal serial bus (USB), or any other suitable connector. The presentation module 715 may also interact with control device 717 for determining particular media content that a user desires to experience. In an exemplary embodiment, control device 717 may comprise a remote control (or other access device having control capability (e.g., computing device 111), a wireless user device, mobile phone, etc.) that provides users with the ability to readily manipulate and dynamically modify parameters affecting the media content being viewed. In other examples, content processing device 700 may be configured for voice recognition such that content processing device 700 may be controlled with spoken utterances.

In this manner, control device 717 may include (not shown) a cursor controller, trackball, touch screen, touch pad, keyboard, and/or a key pad for activating a media application, navigating through broadcast channels, search results, and/or media content identifiers, as well as performing other control functions. For instance, control device 717 may be utilized to maximize a media application, navigate through displayable interfaces, locate/specify/retrieve media content, modify content processing device 700 parameters, or toggle through broadcast channels and/or media content identifiers. Control device 717 may also include functional actuators (e.g., buttons, keys, icons, etc.), such as power on/of, play, pause, stop, fast-forward, reverse, volume up/down, channel up/down, menu, ok/enter, record, info, my content, search, edit, or exit, as well as any other suitable control trigger, such as alphanumeric buttons, shift, control, back, symbols, and the like.

Further, control device 717 may comprise a memory (not illustrated) for storing preferences affecting media content viewed, which can be conveyed to content processing device 700 through an input interface 719. Input interface 719 may support any type of wired and/or wireless link, e.g., infrared, radio frequency (RF), BLUETOOTH, and the like. Thus, control device 717 may store user preferences with respect to media content, such as favorite sources, etc. Alternatively, user preferences may be tracked, recorded, or stored at content processing device 700 or at a network user profile repository 111. The preferences may be automatically retrieved and activated by a user at any time. It is noted that control device 717 may be separate from content processing device 700 or may be integrated within content processing device 700, in which case certain input interface hardware and/or software may be superfluous.

Particular embodiments enable users, via control device 717, to populate or otherwise configure a user profile. For instance, a user profile application may be provided or accessed by content processing device 700 to enable users to populate a plurality of entry fields with user information. A user profile may include one or more customized or personalized settings that affect any aspect of media content accessible via content processing device 700. More specifically, the profile may include: subscription information (account number, user name, password, avatar, moniker, etc.), subscriber demographics (age, gender, ethnicity, location of residence, zip code, school district, community, socioeconomic status, religion, marital status, ownerships, languages, mobility, life cycles, etc.), group/organizational affiliations (e.g., political), memberships, interests, buddies, friends, cohorts, system configurations, policies, associated users/devices, etc., as well as any other like personal information. Additionally, a user profile may include a “whitelist” specifying one or more accessible media content sources/subjects, a “blacklist” specifying one or more media content sources/subjects, as well as other equivalent customized settings, such as color schemes, sound effects, etc.

In other embodiments, the user profile may be established using the additional access devices described earlier (e.g., computing device 111, etc.). As such, user profile information may be stored at content processing device 700, e.g., at memory 713, and/or at a user site repository (not illustrated) directly connected to content processing device 700. Additionally or alternatively, profile information may be stored in a network-based repository (not shown), control device 717, and/or any other storage medium. Similarly, content processing device 700 (via memory 713), a user site repository, and/or a network-based repository may store a collection of digital audio, video and/or image content accumulated by a user. This collection may also include a plurality of identifiers, links, search results, or bookmarks to media content accessible over one or more communication networks 107, wherein selection of a particular identifier, link, search result, or bookmark may cause one or more media applications to obtain the content from an associated link (either directly from a data network source (e.g., content repository (not shown)) or indirectly from third-party content provider system 121 and/or MSP 119).

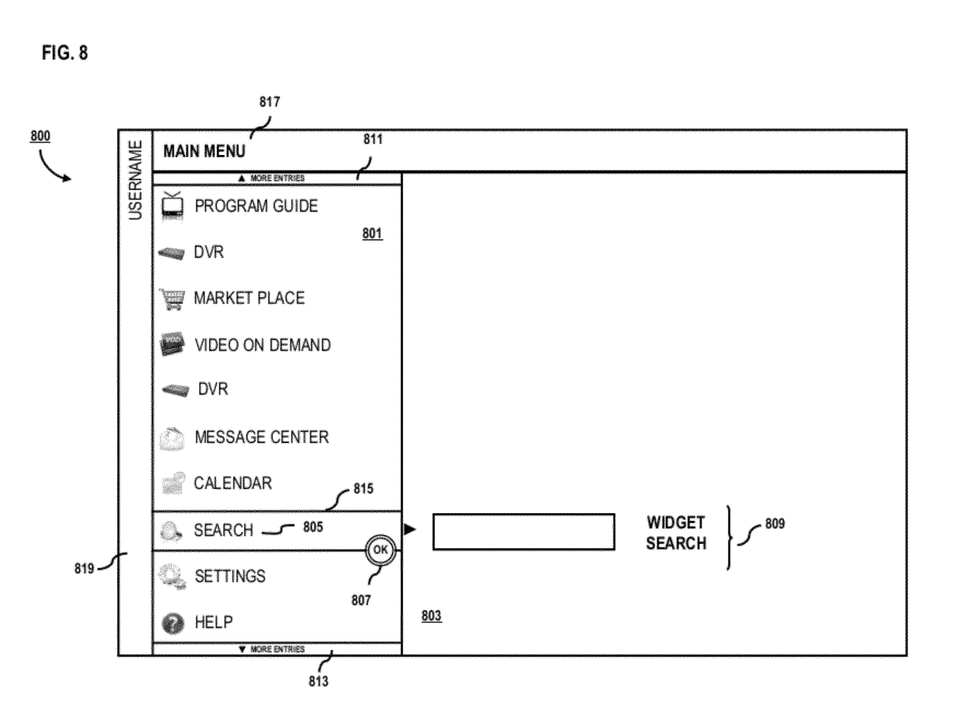

FIG. 8 is a diagram of a graphical user interface (GUI) presented via a set-top box for providing search operations, according to an exemplary embodiment. For example, a user may select a dedicated “MENU” button on control device 717 or a peripheral device communicatively coupled thereto, such as computing device 111, a mobile handset (not shown), and the like. It is recognized that any other suitable actuator of these devices may be additionally, or alternatively, used to access the functionality of main menu 800, such as triggering a “GUIDE” icon. Further, main menu 800 may be evoked by selecting an option within another interface or application, such as, for example, when navigating from a public screen (or navigational shell) to a user-specific screen, i.e., a private screen. As such, an executing device (e.g., content processing device 700, computing device 111, etc.) may require sufficient authentication information (e.g., username and password, etc.) to be input in order to access the functions of main menu 800. It is particularly noted that this authentication information may relate to authentication information associated with a service provider of the search services of system 100.

As seen in FIG. 8, GUI 800, providing a “main menu,” may include one or more interactive viewing panes, such as panes 801 and 803. In particular embodiments, as will be described in more detail below, the content of pane 803 may be dynamically updated to display various menu options, interaction elements, information, etc., related to user interaction within pane 801, and vice versa. In this example, however, pane 801 includes a listing of selectable entries corresponding to one or more features (or options) that may be provided via content processing device 700. For example, entries may include: program guide options, DVR options, marketplace (or shopping) options, on-demand programming options, media manager options, messaging and communications options, searching options, setting options, help options, and the like. In certain embodiments, graphical elements may be provided to correspond to one or more of these entries and, as a result, may be correspondingly displayed therewith. The search options are provided by a search entry 805, which upon selection via an “OK” button 807 invokes a widget search box 809. Accordingly, a user can enter a search query for processing locally at the STB 103 or by search platform 101, as earlier described.

As shown, one or more header 811 and footer 813 fields may be provided and configured to indicate the existence of additional entries not displayed, but navigably available. Accordingly, users may browse through the entries of user interface 800 via, for instance, control device 717 associated with content processing device 700. Further, GUI 800 may include one or more fixed focus states (such as border 815) and/or distinctive magnification features, e.g., color, brightness, bolding, font type, text size, etc., that may be used to convey a “currently” navigated position. In this manner, when a user navigates to a desired entry, actuation of, for instance, an “OK” button on control device 717 may launch (or evoke) corresponding features and/or applications associated with the particular entry. This button can correspond to the interactive “OK” button 807.

In certain other exemplary embodiments, main menu 800 may provide one or more navigation fields 817 and 819 to facilitate usability. For example, field 817 may provide the name of the function/option being accessed, e.g., “MAIN MENU.” In this manner, when a user accesses a new function/option, field 817 may be automatically (or dynamically) updated. Field 819 may be utilized to indicate a user profile “currently” authenticated to system 100, e.g., “USERNAME.” Thus, a user may access one or more features and/or functions associated with the search platform 101 by navigating to and selecting (or otherwise interacting with) an entry of main menu 800.

The above processes and arrangements, according to certain embodiments, advantageously provide a convenient and efficient approach to finding and managing content accessible via a set-top box. In this manner, users can conduct searches of a broad base of content across different platforms with a single search request.

The processes described herein for performing searches across applications via a set-top box may be implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

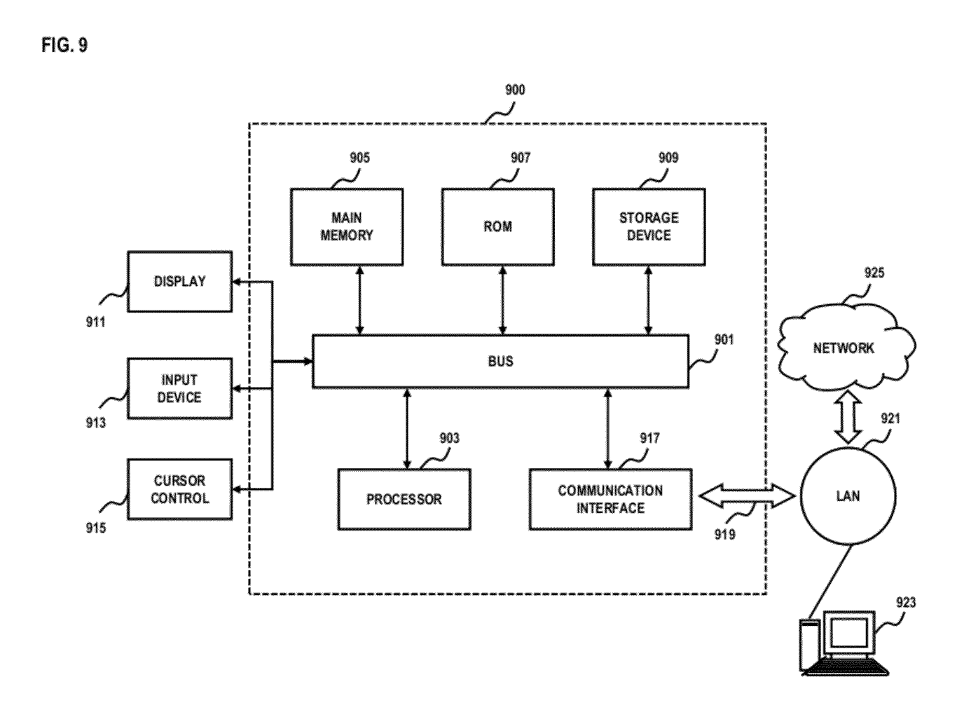

FIG. 9 illustrates computing hardware (e.g., computer system) 900 upon which an embodiment according to the invention can be implemented. The computer system 900 includes a bus 901 or other communication mechanism for communicating information and a processor 903 coupled to the bus 901 for processing information. The computer system 900 also includes main memory 905, such as a random access memory (RAM) or other dynamic storage device, coupled to the bus 901 for storing information and instructions to be executed by the processor 903. Main memory 905 can also be used for storing temporary variables or other intermediate information during execution of instructions by the processor 903. The computer system 900 may further include a read only memory (ROM) 907 or other static storage device coupled to the bus 901 for storing static information and instructions for the processor 903. A storage device 909, such as a magnetic disk or optical disk, is coupled to the bus 901 for persistently storing information and instructions.

The computer system 900 may be coupled via the bus 901 to a display 911, such as a cathode ray tube (CRT), liquid crystal display, active matrix display, or plasma display, for displaying information to a computer user. An input device 913, such as a keyboard including alphanumeric and other keys, is coupled to the bus 901 for communicating information and command selections to the processor 903. Another type of user input device is a cursor control 915, such as a mouse, a trackball, or cursor direction keys, for communicating direction information and command selections to the processor 903 and for controlling cursor movement on the display 911.

According to an embodiment of the invention, the processes described herein are performed by the computer system 900, in response to the processor 903 executing an arrangement of instructions contained in main memory 905. Such instructions can be read into main memory 905 from another computer-readable medium, such as the storage device 909. Execution of the arrangement of instructions contained in main memory 905 causes the processor 903 to perform the process steps described herein. One or more processors in a multi-processing arrangement may also be employed to execute the instructions contained in main memory 905. In alternative embodiments, hard-wired circuitry may be used in place of or in combination with software instructions to implement the embodiment of the invention. Thus, embodiments of the invention are not limited to any specific combination of hardware circuitry and software.

The computer system 900 also includes a communication interface 917 coupled to bus 901. The communication interface 917 provides a two-way data communication coupling to a network link 919 connected to a local network 921. For example, the communication interface 917 may be a digital subscriber line (DSL) card or modem, an integrated services digital network (ISDN) card, a cable modem, a telephone modem, or any other communication interface to provide a data communication connection to a corresponding type of communication line. As another example, communication interface 917 may be a local area network (LAN) card (e.g. for Ethernet™ or an Asynchronous Transfer Model (ATM) network) to provide a data communication connection to a compatible LAN. Wireless links can also be implemented. In any such implementation, communication interface 917 sends and receives electrical, electromagnetic, or optical signals that carry digital data streams representing various types of information. Further, the communication interface 917 can include peripheral interface devices, such as a Universal Serial Bus (USB) interface, a PCMCIA (Personal Computer Memory Card International Association) interface, etc. Although a single communication interface 917 is depicted in FIG. 9, multiple communication interfaces can also be employed.

The network link 919 typically provides data communication through one or more networks to other data devices. For example, the network link 919 may provide a connection through local network 921 to a host computer 923, which has connectivity to a network 925 (e.g. a wide area network (WAN) or the global packet data communication network now commonly referred to as the “Internet”) or to data equipment operated by a service provider. The local network 921 and the network 925 both use electrical, electromagnetic, or optical signals to convey information and instructions. The signals through the various networks and the signals on the network link 919 and through the communication interface 917, which communicate digital data with the computer system 900, are exemplary forms of carrier waves bearing the information and instructions.

The computer system 900 can send messages and receive data, including program code, through the network(s), the network link 919, and the communication interface 917. In the Internet example, a server (not shown) might transmit requested code belonging to an application program for implementing an embodiment of the invention through the network 925, the local network 921 and the communication interface 917. The processor 903 may execute the transmitted code while being received and/or store the code in the storage device 909, or other non-volatile storage for later execution. In this manner, the computer system 900 may obtain application code in the form of a carrier wave.

The term “computer-readable medium” as used herein refers to any medium that participates in providing instructions to the processor 903 for execution. Such a medium may take many forms, including but not limited to computer-readable storage media ((or non-transitory media)—i.e., non-volatile media and volatile media), and transmission media. Non-volatile media include, for example, optical or magnetic disks, such as the storage device 909. Volatile media include dynamic memory, such as main memory 905. Transmission media include coaxial cables, copper wire and fiber optics, including the wires that comprise the bus 901. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the embodiments of the invention may initially be borne on a magnetic disk of a remote computer. In such a scenario, the remote computer loads the instructions into main memory and sends the instructions over a telephone line using a modem. A modem of a local computer system receives the data on the telephone line and uses an infrared transmitter to convert the data to an infrared signal and transmit the infrared signal to a portable computing device, such as a personal digital assistant (PDA) or a laptop. An infrared detector on the portable computing device receives the information and instructions borne by the infrared signal and places the data on a bus. The bus conveys the data to main memory, from which a processor retrieves and executes the instructions. The instructions received by main memory can optionally be stored on storage device either before or after execution by processor.

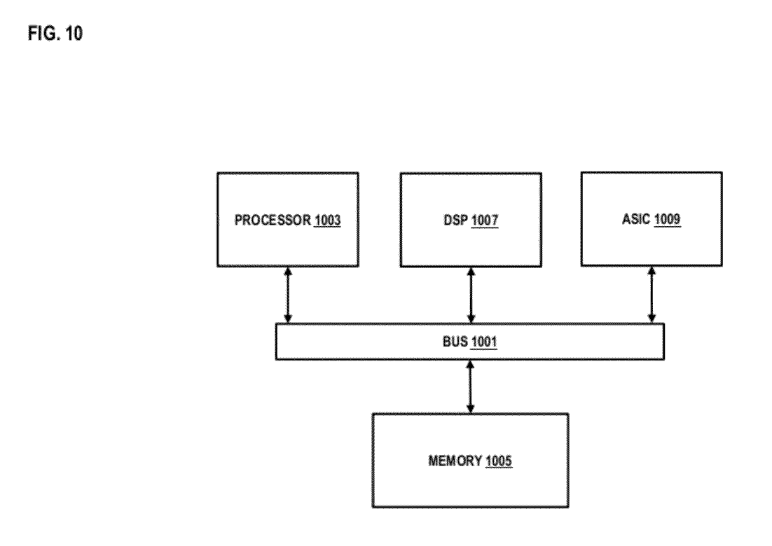

FIG. 10 illustrates a chip set 1000 upon which an embodiment of the invention may be implemented. Chip set 1000 is programmed to present a slideshow as described herein and includes, for instance, the processor and memory components described with respect to FIG. 10 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip. Chip set 1000, or a portion thereof, constitutes a means for performing one or more steps of FIGS. 2, 5, and 6.

In one embodiment, the chip set 1000 includes a communication mechanism such as a bus 1001 for passing information among the components of the chip set 1000. A processor 1003 has connectivity to the bus 1001 to execute instructions and process information stored in, for example, a memory 1005. The processor 1003 may include one or more processing cores with each core configured to perform independently. A multi-core processor enables multiprocessing within a single physical package. Examples of a multi-core processor include two, four, eight, or greater numbers of processing cores. Alternatively or in addition, the processor 1003 may include one or more microprocessors configured in tandem via the bus 1001 to enable independent execution of instructions, pipelining, and multithreading. The processor 1003 may also be accompanied with one or more specialized components to perform certain processing functions and tasks such as one or more digital signal processors (DSP) 1007, or one or more application-specific integrated circuits (ASIC) 1009. A DSP 1007 typically is configured to process real-world signals (e.g., sound) in real time independently of the processor 1003. Similarly, an ASIC 1009 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 1003 and accompanying components have connectivity to the memory 1005 via the bus 1001. The memory 1005 includes both dynamic memory (e.g., RAM, magnetic disk, writable optical disk, etc.) and static memory (e.g., ROM, CD-ROM, etc.) for storing executable instructions that when executed perform the inventive steps described herein to controlling a set-top box based on device events. The memory 1005 also stores the data associated with or generated by the execution of the inventive steps.

While certain exemplary embodiments and implementations have been described herein, other embodiments and modifications will be apparent from this description. Accordingly, the invention is not limited to such embodiments, but rather to the broader scope of the presented claims and various obvious modifications and equivalent arrangements.

What is claimed is:

1. A method comprising:
receiving a search request via an interactive service guide of a set-top box;
initiating a widget-based search of one or more applications via the set-top box;
receiving a search result for the one or more applications; and
presenting the search result via the interactive service guide.

2. A method according to claim 1, further comprising:
retrieving, over a communication network, a master widget that is configured to execute, at the set-top box, the widget-based search across the one or more applications via a corresponding plurality of widgets.

3. A method according to claim 2, wherein the one or more applications are resident on different computing systems.

4. A method according to claim 1, further comprising:
registering a plurality of widgets that corresponding to the applications, respectively, to permit authorized searches of the one or more applications.

5. A method according to claim 1, further comprising:
generating a prompt for specifying a privacy option parameter relating to authorization for the search; and
receiving a user input indicating a value for the parameter in response to the prompt, wherein the parameter value indicates either that the search is authorized for all searches or on a search-by-search basis.

6. An apparatus comprising:
at least one processor; and
at least one memory including computer program code,
the at least one memory and the computer program code configured to, with the at least one processor, cause the apparatus to perform at least the following,
receive a search request via an interactive service guide of a set-top box,
initiate a widget-based search of one or more applications via the set-top box,
receive a search result for the one or more applications, and
present the search result via the interactive service guide.

7. An apparatus according to claim 6, wherein the apparatus is further caused, at least in part, to:
retrieve, over a communication network, a master widget that is configured to execute, at the set-top box, the widget-based search across the one or more applications via a corresponding plurality of widgets.

8. An apparatus according to claim 7, wherein the one or more applications are resident on different computing systems.

9. An apparatus according to claim 6, wherein the apparatus is further caused, at least in part, to:
register a plurality of widgets that corresponding to the applications, respectively, to permit authorized searches of the one or more applications.

10. An apparatus according to claim 6, wherein the apparatus is further caused, at least in part, to:
generate a prompt for specifying a privacy option parameter relating to authorization for the search; and
receiving a user input indicating a value for the parameter in response to the prompt, wherein the parameter value indicates either that the search is authorized for all searches or on a search-by-search basis.

11. A method comprising:
receiving a search request over a communication network from a set-top box;
performing a widget-based search of one or more applications in response to the search request;
generating a search result for the one or more applications; and
initiating transmission of the search result for presentation of the search result via an interactive service guide of the set-top box.

12. A method according to claim 11, further comprising:
receiving a request, from the set-top box, for downloading of a master widget; and
retrieving the master widget in response to the download request, wherein the master widget is configured to execute, at the set-top box, the widget-based search across the one or more applications via a corresponding plurality of widgets.

13. A method according to claim 12, wherein the one or more applications are resident on different computing systems.

14. A method according to claim 11, wherein the set-top box is configured to register a plurality of widgets that correspond to the applications, respectively, to permit authorized searches of the one or more applications.

15. A method according to claim 11, wherein the set-top box is configured to generate a prompt for specifying a privacy option parameter relating to authorization for the search, and to receive a user input indicating a value for the parameter in response to the prompt, wherein the parameter value indicates either that the search is authorized for all searches or on a search-by-search basis.

16. An apparatus comprising:
at least one processor; and
at least one memory including computer program code,
the at least one memory and the computer program code configured to, with the at least one processor, cause the apparatus to perform at least the following,
receive a search request over a communication network from a set-top box,
perform a widget-based search of one or more applications in response to the search request,
generate a search result for the one or more applications, and
initiate transmission of the search result for presentation of the search result via an interactive service guide of the set-top box.

17. An apparatus according to claim 16, wherein the apparatus is further caused, at least in part, to:
receive a request, from the set-top box, for downloading of a master widget; and
retrieve the master widget in response to the download request, wherein the master widget is configured to execute, at the set-top box, the widget-based search across the one or more applications via a corresponding plurality of widgets.

18. An apparatus according to claim 17, wherein the one or more applications are resident on different computing systems.

19. An apparatus according to claim 16, wherein the set-top box is configured to register a plurality of widgets that correspond to the applications, respectively, to permit authorized searches of the one or more applications.

20. An apparatus according to claim 16, wherein the set-top box is configured to generate a prompt for specifying a privacy option parameter relating to authorization for the search, and to receive a user input indicating a value for the parameter in response to the prompt, wherein the parameter value indicates either that the search is authorized for all searches or on a search-by-search basis.
